(19) United States
(12) Patent Application Publication
(10) Pub. No.: US 2026/0016025 A1
(43) Pub. Date: Jan. 15, 2026

(54) GUIDEWIRE TERMINATION DEVICE AND METHOD

(71) Applicant: Joseph P Gentile, Milton, GA (US)

(72) Inventor: Joseph P Gentile, Milton, GA (US)

(21) Appl. No.: 19/333,348

(22) Filed: Sep. 19, 2025

Related U.S. Application Data
(63) Continuation-in-part of application No. 18/427,798, filed on Jan. 30, 2024, now Pat. No. 12,448,980.

(51) Int. Cl. F04D 29/64; F16M 13/02

(52) U.S. Cl. CPC F04D 29/646; F16M 13/027

(57) ABSTRACT

A method and apparatus for securing a guidewire to a fan-supporting receiving structure. A retainer includes a bolt, integrally formed with a threaded body defining a hollow interior with a cylindrical bore through which the guidewire extends. Rotation of the bolt drives the body's external threads into an opening in a wall of the receiving structure to fasten the retainer. A semi-spherical cap affixed to the guidewire end has a maximum diameter smaller than the wall opening to permit insertion into the receiving structure and a minimum diameter larger than the bore diameter to prevent pull-through through the hollow interior. With the cap positioned inside the receiving structure and the guidewire routed through the bore, the retainer establishes a captured, tensile-resistant connection that installs from one side of the wall and securely anchors fan guidewires while remaining compatible with standard openings and manufacturing methods.

### TECHNICAL FIELD

These claimed embodiments relate to a method and apparatus for securing a hanging structure such as a rotating fan and more particularly to securing a rotating fan with a guidewire termination device.

### BACKGROUND OF THE INVENTION

The subject matter relates to hardware for suspending and stabilizing fans, and more particularly to apparatus, assemblies, and methods for securing a guidewire to a receiving structure that supports a fan.

Fans mounted from overhead structures (e.g., tubes, masts, rails, beams, or housings) are commonly stabilized with guidewires to control sway, vibration, and transient loads. Conventional attachments often employ through-bolts with backside nuts, eye bolts, rivet nuts, knock-in anchors, separate grommets or bushings, and multi-piece terminations on the wire end. These solutions can require access to the far side of a wall, introduce sharp edges at the wire interface, and depend on installers manipulating loose hardware inside a confined cavity—none of which is ideal for retrofit or elevated work.

In many fan installations the receiving structure is a tube or similar member with limited or no backside access. Through-bolting can be impractical, and blind inserts may spin, loosen, or require specialized setting tools. Multi-piece retainers increase part count and time aloft. There is a continuing need for a retainer that can be driven from one side of a wall opening and that positively captures the guidewire without separate interior hardware.

Guidewire terminations routed through abrupt shoulders or narrow bores can kink the wire, violate minimum bend radius, and create stress concentrations that lead to premature fatigue. Sharp transitions at the entry point can also abrade coatings or strands. Conventional devices do not consistently provide a controlled, smooth transition that both funnels the wire during installation and protects it in service.

Many common stops or swaged ends are either too large to pass through standard wall openings or, if sized to pass through, can still pull back through the retainer bore under load. Solutions that rely on interior nuts, washers, or brackets to create a bearing surface inside the structure complicate assembly and are not always feasible in blind cavities.

### BRIEF DESCRIPTION OF THE DRAWINGS

The detailed description is described with reference to the accompanying figures. In the figures, the left-most digit(s) of a reference number identifies the figure in which the reference number first appears. The use of the same reference number in different figures indicates similar or identical items.

FIGS. 1A-1C are an isometric view, a front plan view and a side plan view of a fan supporting device for hanging a fan on a rail;

FIG. 2 is an exploded view of plates of the fan supporting device shown in FIGS. 1A-1C;

FIGS. 3A-3C are a front plan view, a side plan view and an exploded view of a fan supporting device shown in FIGS. 1A-1C for hanging a fan on a rail using a single plate;

FIGS. 4A-4C are a front plan view, a side plan view, and a partially exploded view, of a fan supporting device for hanging a fan on an I-beam;

FIG. 5A is an isometric view of the fan supporting device shown in FIGS. 4A-4C;

FIG. 5B is an isometric view of the novel Self-aligning clamp connecting the connecting plate to a flange of the I-beam shown in FIG. 5A;

FIG. 5C is a side plan view of a self-aligning clamp shown in FIG. 5B;

FIG. 5D is a side plan view of a self-aligning clamp shown in FIG. 5C in an alternate configuration with a thinner I-beam;

FIG. 6 is a plan view of the guidewire termination device that includes a receiving structure of the fan supporting device shown in FIGS. 1A-1C with guidewires mounted on the structure;

FIG. 7A is a side view of the guide wire shown in FIG. 6;

FIG. 7B is a top view of the retainer shown in FIG. 6;

FIG. 7C is cross sectional view of the retainer shown in FIG. 7B; and

FIG. 7D is a cross sectional view of the retainer shown in FIG. 7C with a cap and guidewire inserted therein.

Referring to FIG. 8A and FIG. 8B, there is shown side view and a perspective view of an alternative version of a Guidewire Termination device;

Referring to FIG. 9 and FIG. 10, there is shown a cross section view of a bolt forming an aperture therein shown inf FIG. 8A and FIG. 8B.

Shown in FIG. 11, there is a perspective view of Z perlins attached to struts and a ceiling.

FIGS. 12A-D are plan views of aspects of a multicolor rotating fan cover on a guide wire.

### DETAILED DESCRIPTION

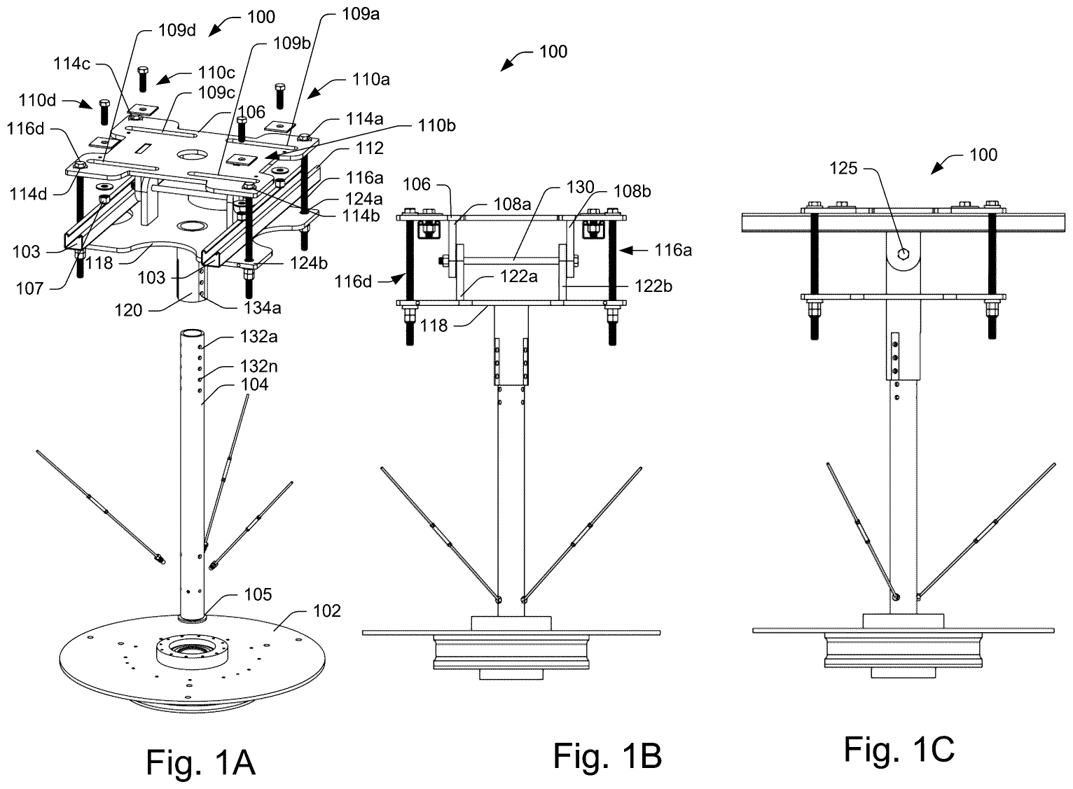

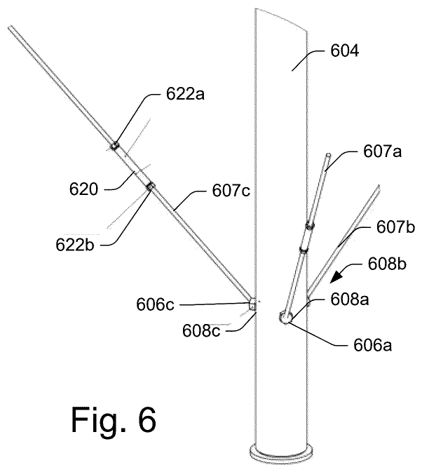

Referring to FIGS. 1A-1C, there is shown fan support device 100 that includes a rotating fan 102 (or any a hanging structure, such as a light fixture, exercise equipment, picture frame, sculpture, cooling device, etc.) attached at one end of a cylindrical tube 104 (also referred to as a receiving structure). Tube 104 has a cylindrical lip 105 that wraps around tube 104 one end to support rotating fan 102. Further details of cylindrical tube 104 are described in connection with FIG. 6, and 7A-7D.

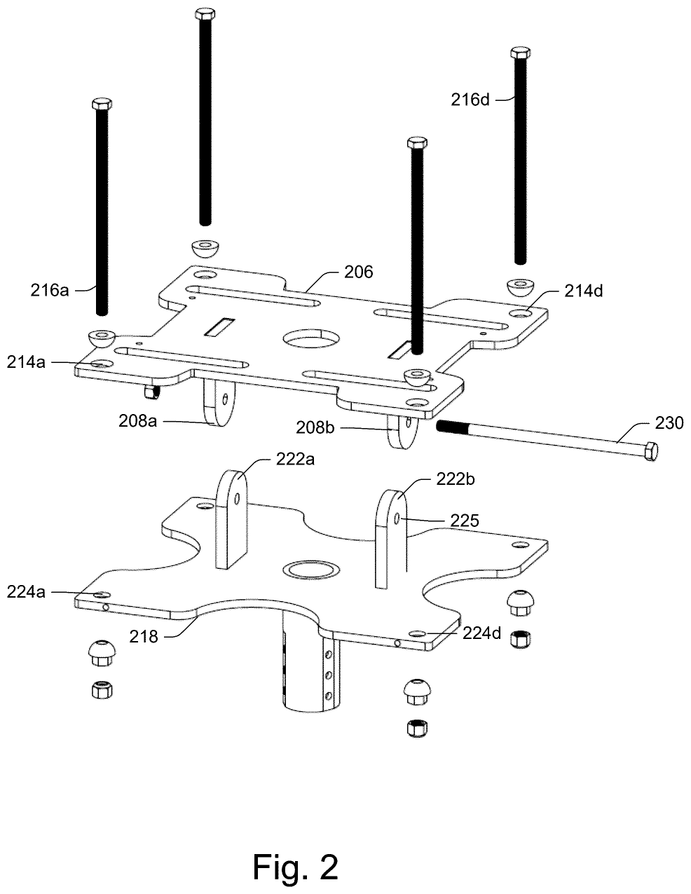

Referring to FIGS. 1A-C and 2, a ceiling attaching structure is attached at the other end (another end) of tube 104 distal from the rotating fan 102. The fan support device 100 includes a flat plate 106 (plate 206 in FIG. 2) coupled with flat plate 118 that connects to a ceiling attaching structure, such as a beam or a rail as described herein. Flat plate 106 forms elongated openings 109a-d (also referred to apertures), with openings 109a and 109b extending in a first line, and openings 109c and openings 109d extending in a second line such that the first line is parallel to the second line.

Referring to FIG. 1, slidable fastener 110a, slidable fastener 110b, slidable fastener 110c, and slidable fastener 110d (that includes a screw, bolt and multiple washers) are fed through one of multiple elongated openings 109a-n in plate 106 to engage with a lip 112 of a rail 103 to secure rail 103 to plate 106. In one implementation, a washer and bolt 107 reside in rail 103. One of screws of fasteners 110a-d is fed though a washer and one of the elongated openings 109a (also referred to as elongated apertures), and elongated openings 109b-n into the washer and the bolt that reside in the rail 103. Referring to FIGS. 1A-1C and 2, plate 106 (206 in FIG. 2) forms circular aperture 114a, circular aperture 114b, circular aperture 114c, and circular aperture 114d (214a-d in FIG. 2) therein to receive connectors 116a-d (216a-d in FIG. 2).

Flat plate 118 (plate 218 of FIG. 2) is coupled with a cylindrical tube 120 that extends perpendicularly away therefrom. Tube 120 receives and retains the cylindrical tube 104. Flat plate 118 has tongue 122a and tongue 122b (tongue 222a and tongue 222b of FIG. 2) extending perpendicular to flat plate 118 and engages with tongue 108a and tongue 108b (tongue 208a and tongue 208b of FIG. 2) with connector 130 (connector 230 of FIG. 2) (exemplary connector 130 includes a screw). Flat plate 118 forms aperture 124a, and apertures 124b-d to receive fastener 110a that extend via forms circular apertures 114a-d to engage adjacent a distal end of connector 116a, and connectors 116b-d. Fasteners 110b-d (e.g., screws) extend through openings 109a-d into rail 103.

Tongues 108a-n and tongues 122a-n each form an opening 125 (opening 225 of FIG. 2). The tongues 108a-b engage with the tongues 122a-b respectively by each receiving connector 130 that extends through the openings 125 of tongues 108a-b and tongues 122a-b.

Each of connectors 116a-d includes a screw and a bolt. The bolts of the plurality of connectors 116a-d engage with the flat plate 118 and a head of a screw on connectors 116a with plate 106. Bolts can be tightened or loosened on the screw to flat plate 106 and flat plate 118 about connector 130 to change an angle of a plane of a top surface of flat plate 118 with respect to an angle of a plane of a top surface of flat plate 106.

Aperture 132a, aperture 132b-n, and aperture 134a and apertures 134b-n are formed in tube 104 and tube 120, respectively. Apertures 132a-n, and apertures 134a-n align when tube 104 is inserted into tube 120. A pin (not shown) may be inserted at different location of the one or more of the aligned apertures 132a-n and 134a-n to change the distance between fan 102 and rail 103.

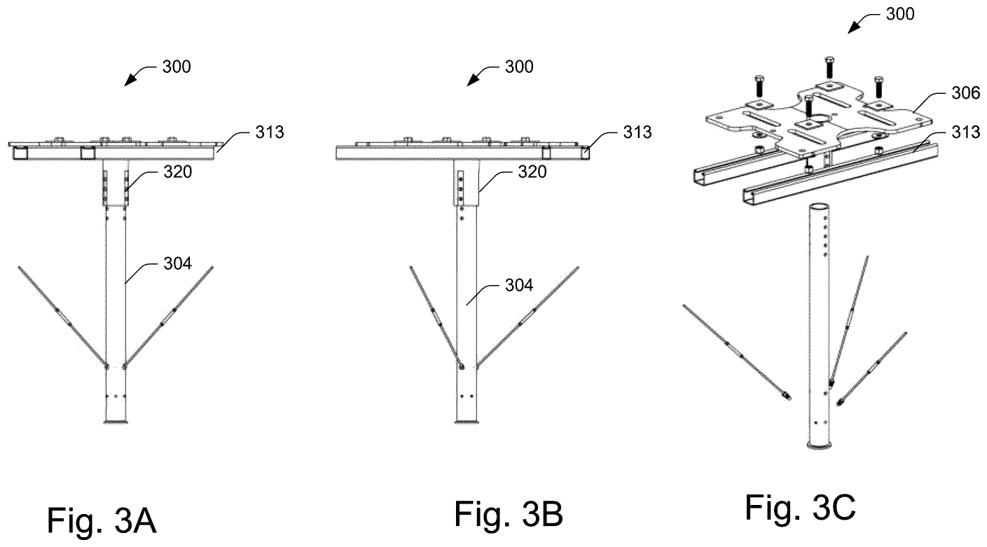

Referring to FIGS. 3A-3C, there is shown fan support device 300, using a single plate 306 (plate 106 of FIG. 1) that connects to rails 313 (rail 103 as described in FIG. 1). Plate 306 is coupled with a cylindrical tube 320 that extends perpendicularly away therefrom. Tube 320 receives and retains the cylindrical tube 304 (Tube 104 of FIG. 1) that holds a fan (not shown).

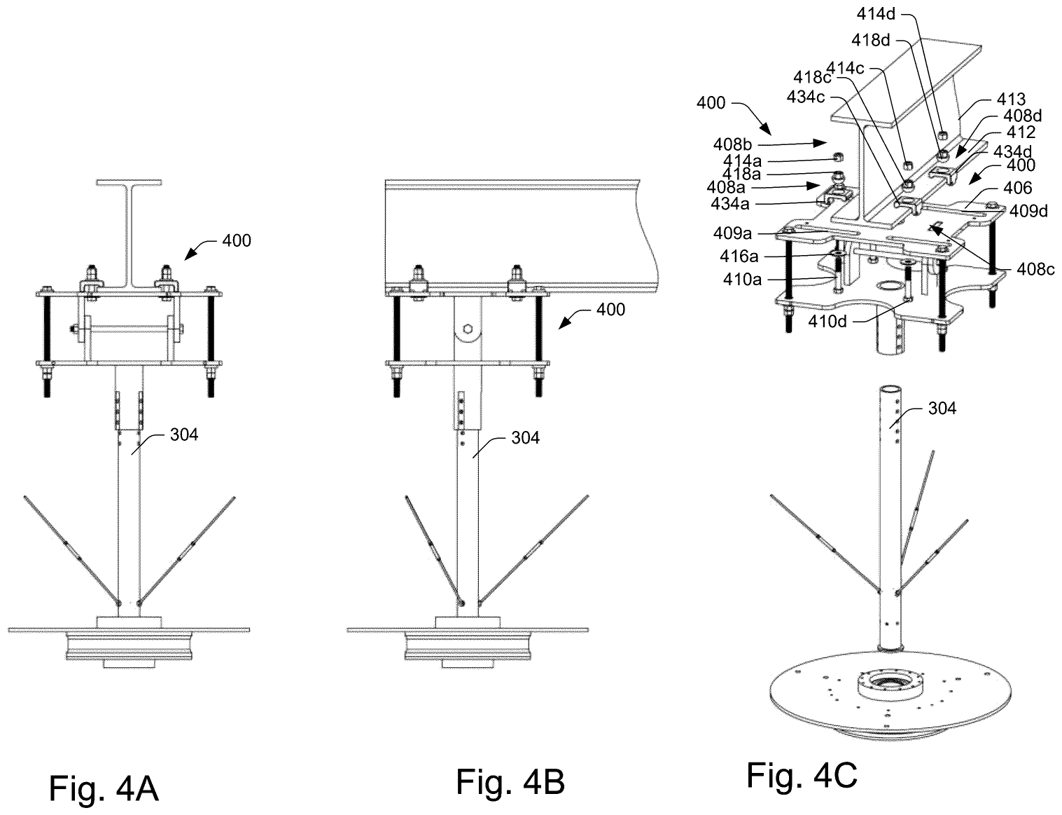

Referring to FIGS. 4A-4C, there is shown fan support device 400, that is like fan support device 100 as described in FIG. 1, with connecting plate 406 (plate 106 of FIG. 1) connected to I-beam 413 using slidable fastener 408a, slidable fastener 408b, slidable fastener 408c and slidable fastener 408d (each respectively includes screw 410a, screw (not shown), screw 410c, screw 410d, bolt 414a, bolt 414c and bolt 414d, regular washer 416a, regular washers 416c-d, hemispherical washer 418a, hemispherical washer (not shown), hemispherical washer 418c, self-aligning clamp 418d, self-aligning clamp 434a, self-aligning clamp 434c, and self-aligning clamp 434d (also individually referred to as an L-shaped bracket)). Screws 410a-410d are each fed via regular washers 416a-d through one of multiple elongated openings 409a (and opening 409b, opening 409c and opening 409d) in plate 106 (and via an aperture in hemispherical washers 418a-d and self-aligning clamps 434a-d) to couple with bolt 414a, and bolt 414-d. Self-aligning clamp 434a, self-aligning clamp 434c, and self-aligning clamp 434d engage with a I-beam flange 412 of I-beam 413 to secure connecting plate 406 to I-beam 413.

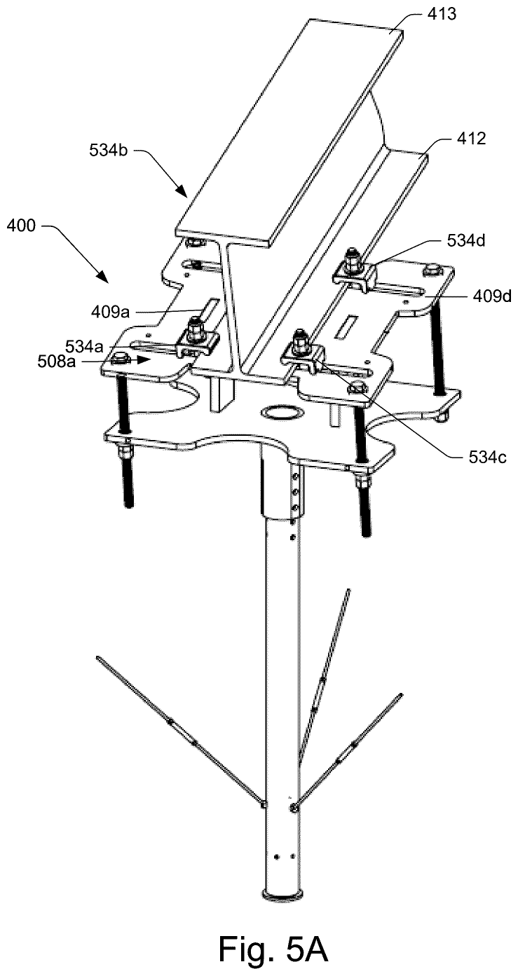

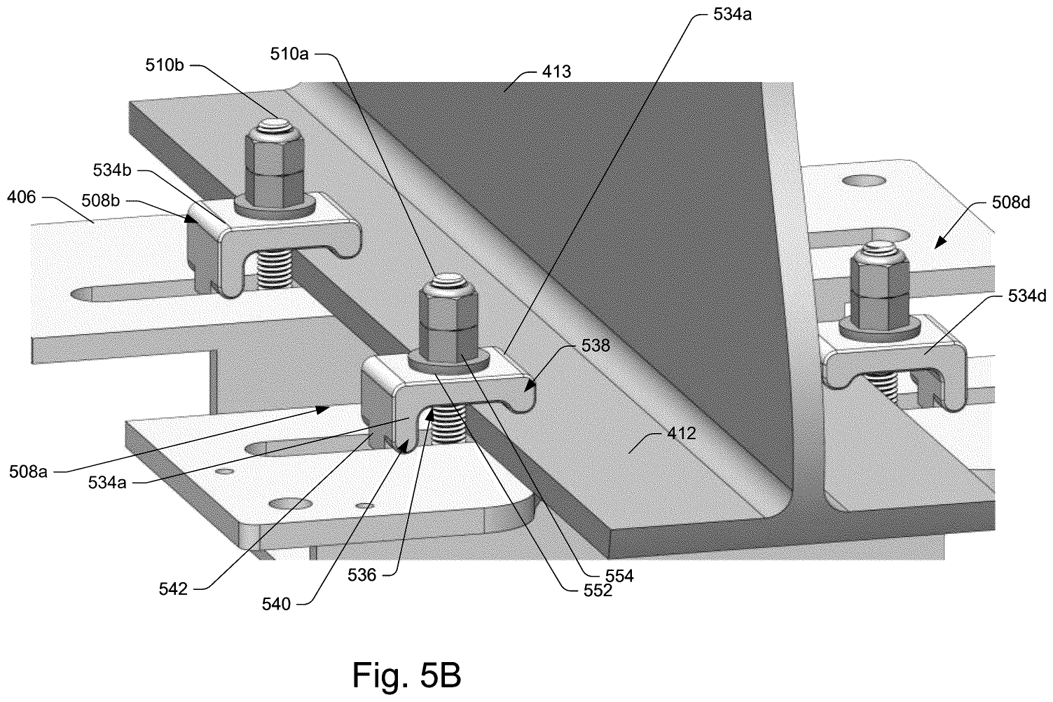

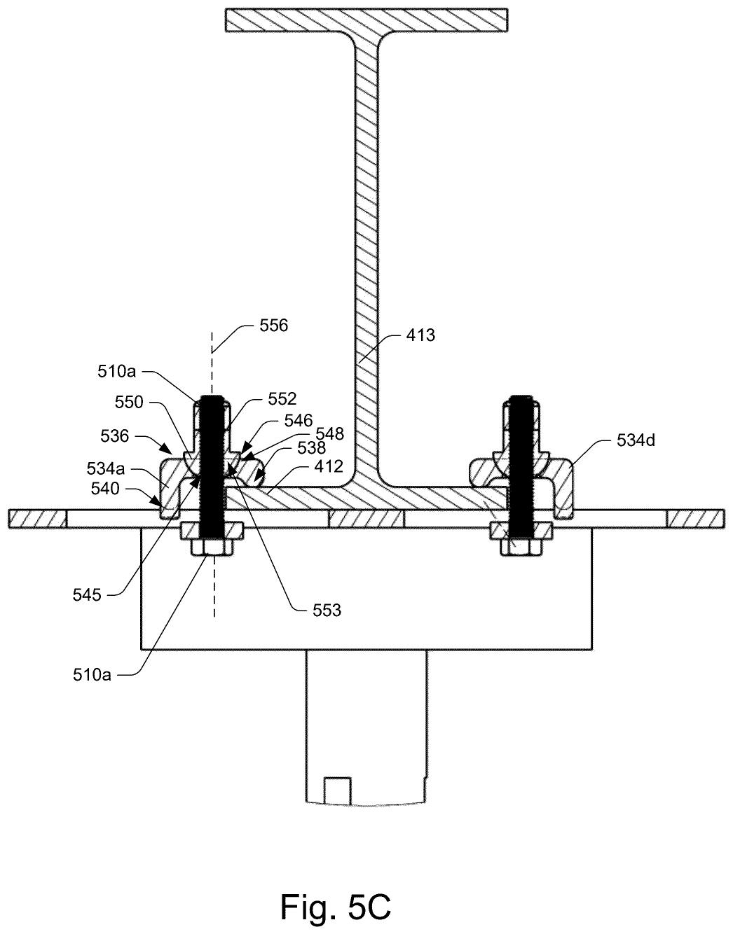

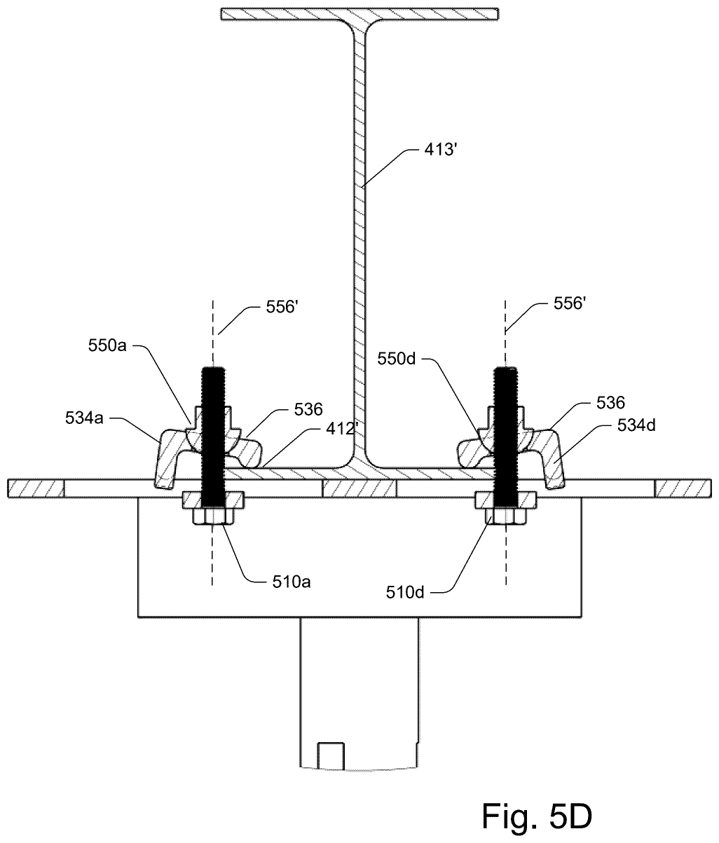

Referring to FIG. 5A, fasteners 508a, and fasteners 508b-d (Slidable fastener 408a, and slidable fasteners 408b-d of FIG. 4C) may extend (with a screw) via elongated openings 409a-d and openings in self-aligning clamp 534a, self-aligning clamp 534b, self-aligning clamp 534c and self-aligning clamp 534d to (also individually referred to as an L-shaped bracket) engage I-beam flange 412 of I-beam 413 with connecting plate 406.

Referring to FIG. 5B, there are shown further details of fasteners 508a-d. Referring to FIGS. 5A and 5B, exemplary fastener 508a (and fastener 508b) includes Self aligning clamp 534a coupling connecting plate 406 with I-beam flange 412 of I-beam 413. Self-aligning clamp 534a includes a flat portion 536 (with a flat upper surface and a flat bottom surface with a plane extending along the flat upper surface and another plane extending along the flat bottom surface), an upper lip portion 538 and a lower lip portion 540. Upper lip portion 538 and lower lip portion 540 each have an outer edge. Fastener 508a and fastener 508b includes screw 510a and screw 510b (which may be threaded at one end) respectively. Upper lip portion 538 and lower lip portion 540 extend perpendicularly away from the plane of the flat bottom surface in a same direction on the same side of flat portion 536, with lower lip portion 540 outer edge extending further away from the plane of the lower surface of flat portion 536 than upper lip portion 538 outer edge extends away from the plane of the lower surface of flat portion 536.

Self-aligning clamp 534a (and self-aligning clamps 534b-d) includes an integrated stop portion 542. Stop portion 542 extends away from and parallel to lower lip portion 540 (perpendicular to the plane extending through a lower surface of flat portion 536) into elongated opening 544 (multiple elongated opening 409a, and elongated openings 409b-d of FIGS. 4A-4C) of connecting plate 406. Stop portion 542 has a distal portion with a width slightly less than the width of multiple elongated openings 409a-d and has a width less than a width of lower lip portion 540. Stop portion 542 prevents Self aligning clamp 534a from sliding outside of elongated opening 544 and prevents self-aligning clamp 534a (and self-aligning clamps 534b-d) from rotating in elongated opening 544 while enabling Self aligning clamp 534a (and self-aligning clamps 534b-d) to slide along elongated opening 544.

Referring to FIG. 5C, there is shown a side cutout view of Self aligning clamp 534a. Flat portion 536 of Self aligning clamp 534a (and self-aligning clamp 534d) includes a bowl-shaped cutout section or socket 546 having inwardly recessed walls 548 in which a hemispherical washer 550 (hemispherical washer 418a of FIGS. 4A-4C) resides. Hemispherical washer 550 preferably includes a ridge section (referred to herein as integrated cap 552) with a flat top surface integrally connected to a hemispherical section 553 (also referred to herein as a hemispherical shaped portion). Cap 552 may be hexagonal shaped so that it may be turned on screw 510a using a tool. Socket 546 and hemispherical washer 550 form an opening 545 to receive screw 510a.

Hemispherical washer 550 is configured to pivot within cutout section 546 and is prevented from rotating by stop portion 542. Hemispherical washer 550 pivots in socket 546 of self-aligning clamp 534a to orient of an axis 556 extending upward through the screw 510a at a first angle with respect to a plane of the top surface of flat portion 536 to secure the connecting plate 406 to the I-beam 413 with the outer edge of upper lip portion 538 and the outer edge of lower lip portion 540 when the I-beam flange 412 has a first thickness. When I-beam flange 412 has a different thickness see axis 556′ of screw 510a and screw 510d in FIG. 5D.

Referring to FIG. 5B and FIG. 5C, when attaching connecting plate 406 to I-beam 413, Self-aligning clamp 534a is placed on I-beam 413 so that upper lip portion 538 contacts I-beam flange 412 and lower lip portion 540 contacts a top surface of connecting plate 406. Screw 510a (also referred to as a fastener) is fed through a washer (washer 416a of FIGS. 4A-4C), elongated opening 544, an aperture in socket 546 and an opening 545 in hemispherical washer 550 through integrated cap 552 (or a washer may be used in place of integrated cap 552) and into locking bolt 554.

Locking bolt 554 and integrated cap 552 (also referred to as a bolt head or bolt heads) may be rotated on screw 510a to tighten and hold fastener 508a to connecting plate 406 and I-beam flange 412. Before tightening fastener 508a (as well as fasteners 508b-d), self-aligning clamp 534a (as well as self-aligning clamps 534b-d) including screw 510a may slide along one of elongated openings 544 in connecting plate 406 to attach the upper lip portion 538 to I-beam flange 412. As the integrated cap 552 is torqued, the self-aligning clamp 534a undergoes elastic deformation that forces the upper lip portion 538 into an engagement with the I-beam flange 412. Greater pressure is then applied to the lower lip portion 540 of the Self aligning clamp 534a. Since Self aligning clamp 534a and self-aligning clamp 534d oppose each other, the upper lip portion 538 of Self aligning clamp 534a and Self aligning clamp 534d are forced into the I-beam flange 412 improving immobility and reducing the probability of fan support device 400 loosening from I-beam 413.

Referring to FIG. 5D, self-aligning clamp 534a is placed on a thinner I-beam 413′ with a thinner I-beam flange 412′ than the I-beam flange 412 of I-beam 413 shown in FIG. 5C. When placed on the thinner I-beam flange 412′, Self-aligning clamp 534a on one side of L-beam 413′ and Self aligning clamp 534d on another side of L-beam 413′ are slid on elongated openings 544 and pivot with respect to hemispherical washer 550a and 550d, respectively. When the I-beam flange 412′ of I-beam 413′ has a second different thickness than I-beam flange 412 (FIG. 5C), the hemispherical washer 550 pivots in socket 546 of self-aligning clamp 534a (and self-aligning clamp 534d) to orient the axis 556′ extending upward through the screw 510a (and screw 510d) at a second different angle with respect to the a plane of the upper surface of flat portion 536 to secure the connecting plate 406 to the I-beam 413′.

Referring to FIG. 6, there is shown a cylindrical tube 604 (Tube 104 of FIG. 1). As described in FIG. 1, the cylindrical tube 604 (cylindrical tube 604 is also referred to herein as a receiving structure, an elongated member, or elongated members) attaches at one end to a rotating fan and attaches at its other end to a ceiling attaching structure as previously described. Cylindrical tube 604 can be a hollow tube, or a solid tube (with a blind hole) structural element of the equipment to be stayed with the guide wire (as described herein).

Threaded aperture 608a, threaded aperture 608b and threaded aperture 608c (referred to collectively as threaded apertures) are formed in the cylindrical tube 604 between the rotating fan and the ceiling support structure.

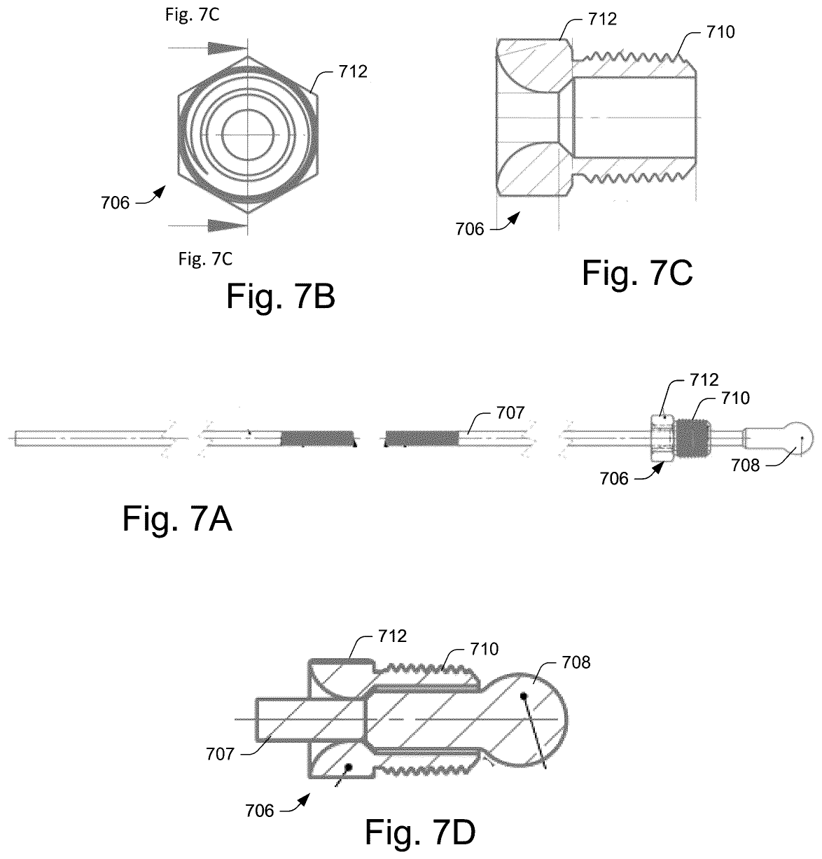

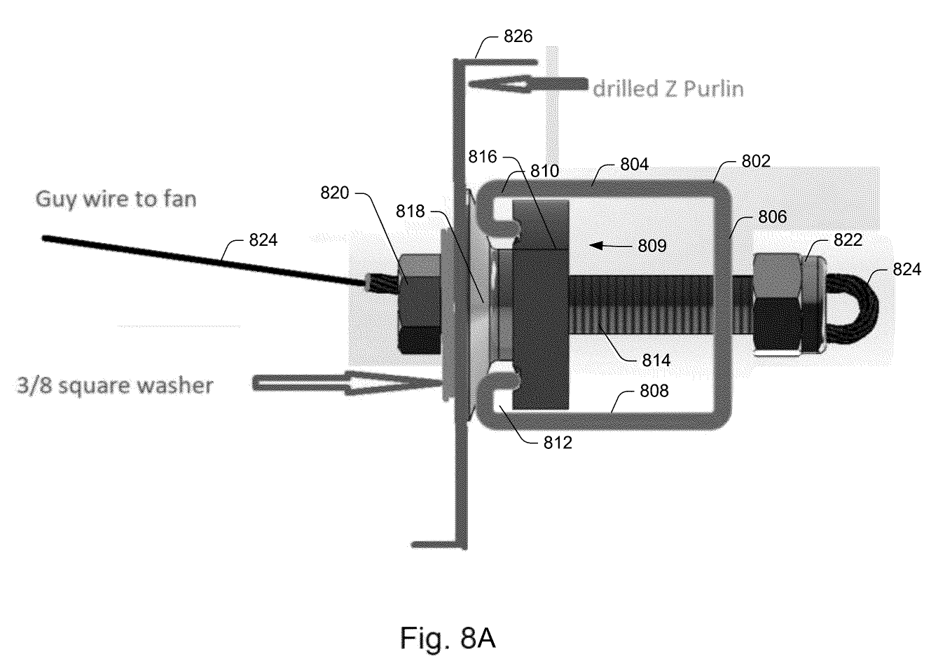

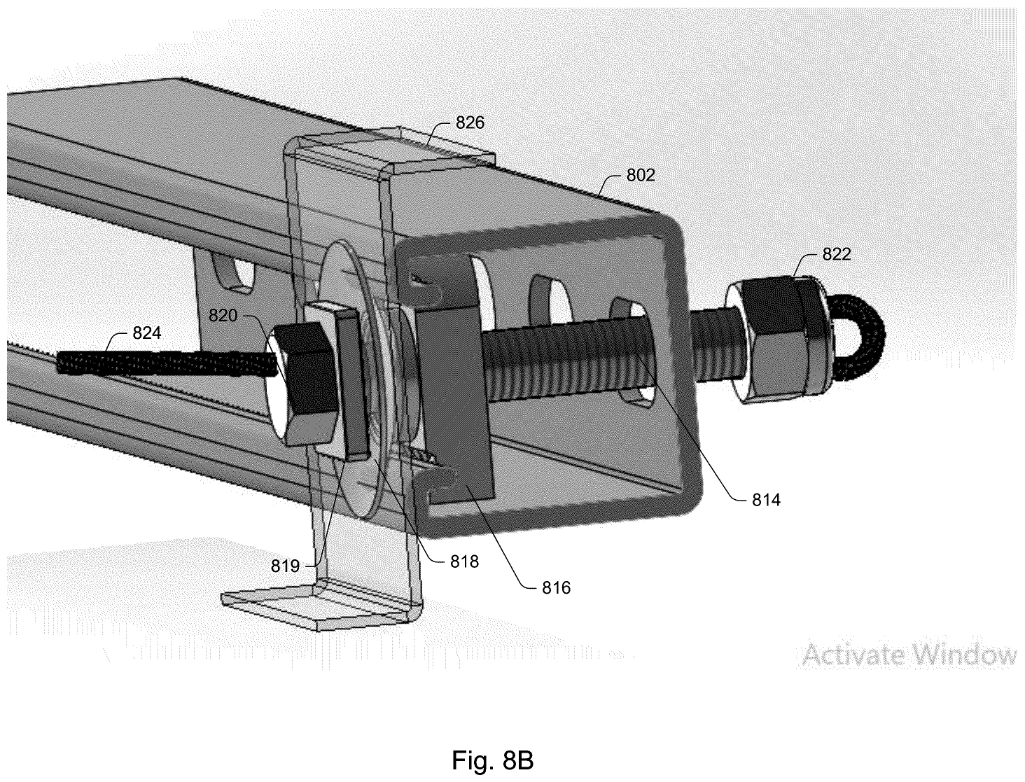

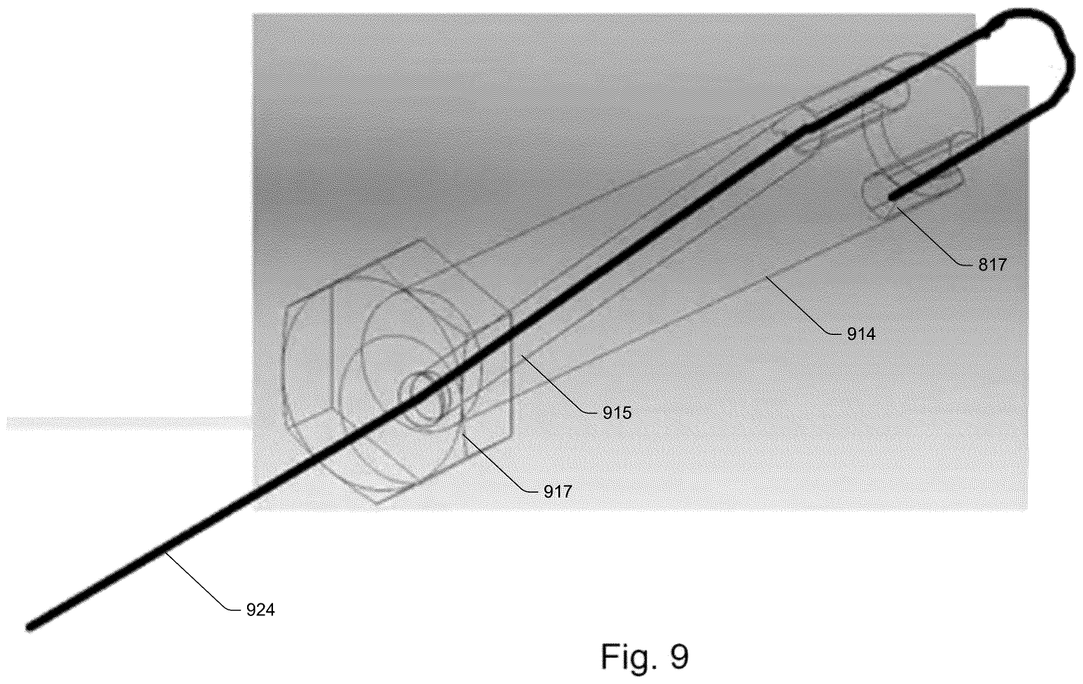

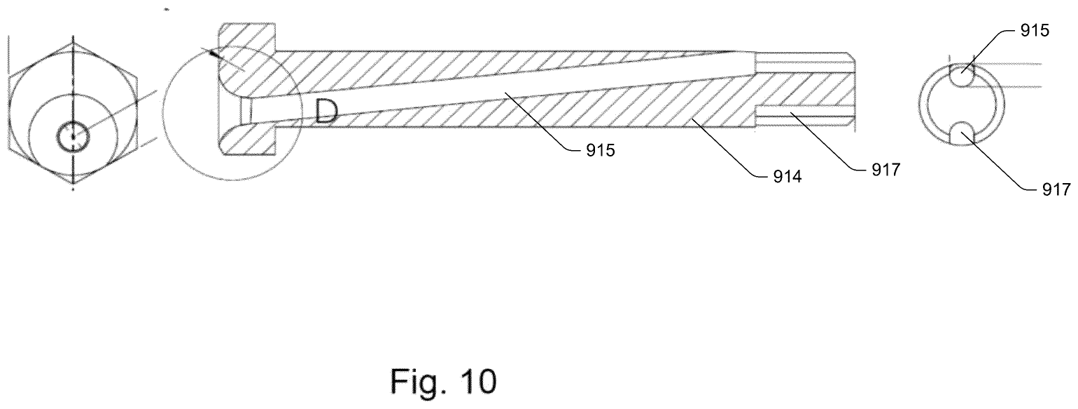

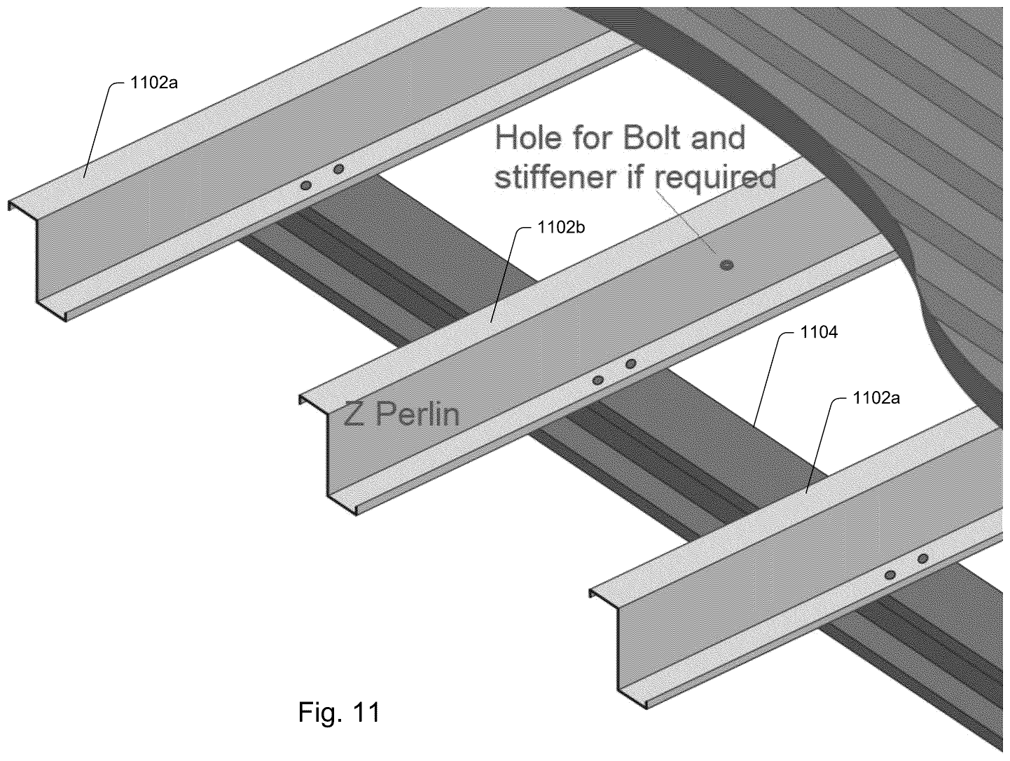

Referring to FIGS. 7A-D, there is shown retainer 706 that includes a hollow hex bolt head (referred to herein as bolt 712) integrally coupled with a hollow body 709. External threads 710 are formed on the exterior of hollow body 708. External threads 710 taper from the bolt 702 at one end of hollow body 709 to the other end of hollow body 709, and screw into apertures 608a-608c (also referred to as openings) to assist in locking retainer 706 to tube 604.

Referring to FIG. 7A, there is shown a guidewire 707 having an integrally connected cap 708 at one end (FIGS. 7A and 7D) that is fed through a retainer 706. Cap 708 (also referred to as a ball end) is preferably swaged, soldered, glued, or crimped to one end of guidewire 707. One portion of cap 708 is spherically shaped with a diameter greater than the internal diameter of body 709, and another portion of cap 708 tapers to a diameter less than the maximum inner diameter of the body 709.

Preferably, the guidewire 707 terminates in a tapered cap 708. The cap 708 is dimensioned such that its maximum outer diameter is greater than the minimum inner diameter of the body 709 and, in certain embodiments, is less than the minor (root) diameter of an internal retaining feature 710 (e.g., internal threads or a locking ring) formed in the body 709. A bolt 712 (collar) is slidably received over the guidewire 707 and defines a through-bore whose inner diameter is greater than the maximum outer diameter of the guidewire 707 and less than the minimum outer diameter of the cap 708, thereby allowing the bolt 712 to translate along the guidewire while preventing the cap 708 from passing through the bolt.

The through-bore of the bolt 712 preferably tapers smoothly (e.g., monotonically, proportionally or exponentially) from a smaller diameter at the end facing away from the cap 708 to a larger diameter at the end facing the cap 708, forming a funnel that eliminates sharp edges and preserves the minimum bend radius of the cable. In some embodiments, the retaining feature 710 tapers from the bolt-facing end toward the cap-facing end so that, when the bolt 712 is advanced into the apertures 608a-608c, the interaction of the opposed tapers locks the cap 708 in place. The smallest outer diameter of the bolt 712 exceeds the largest outer diameter of the body 709 to preclude insertion of the bolt into the body 709. Dimensions of the cap 708, bolt 712, and retaining feature 710 scale proportionally with cable size.

Referring to FIGS. 6 and 7A-7D, retainer 606a, retainer 606b and retainer 606c (Retainer 706 of FIGS. 7A-7D) slide over each of the guidewire 607a, guidewire 607b and guidewire 607c with a tapered end of cap 708 inserting into ring 710 of retainers 606a-c. Retainers 606a-c are screwed into aperture 608a, aperture 608b and aperture 608c (openings) by rotating head of bolt (bolt head) 712, such that the bolt is stopped and does not screw completely into cylindrical tube 604. After screwing the retainers 606a-c into the apertures 608a-c, caps 708 of each retainers 606a-c are disposed within the cylindrical tube 604 and the other end of the guide wires 607a-c are disposed distal from the cylindrical tube 604. The distal end of guide wires 607a-c can be attached to a fixed object to support (e.g., prevent movement) cylindrical tube 604 and the fan 102.

Referring to FIG. 6, a turnbuckle 620 may be attached to each of the wires 607a-c with a locknut 622a and 622b on each end of the turnbuckle 620. The turnbuckle 620 may be turned to tighten or loosen each of the guidewires 707 from the fixed object, respectively.

Referring to FIG. 8A and FIG. 8B, there is shown Termination device 800, an alternative version of a Guidewire Termination device 700 in FIG. 7. Termination device 800 includes a channel strut 802 having a top side 804, back side 806 and bottom side 808 with an open front side 809. A wrap around channel 810 and channel 812 is formed on the top side 804 and bottom side 808 of channel strut 802 that both extend along the length of the channel strut 802. A bolt 814 forming an aperture therein (See FIG. 9 and FIG. 10) extends through a square washer 816, round washer 818, square washer 819 and square nut 820 (having an aperture to receive the guidewire 824 and extend through aperture 815), then through aperture formed on the back side 806 and then held in place with nut 822. Square washer 816 rotates about an axis extending through bolt and is disposed on the body of bolt 814 to secure channel strut 802 to bolt nut 820.

Guidewire 824 is attached to a fan at one end (See FIG. 6) and at its other end, extends through an aperture 815 extending lengthwise at a diagonal angle though the length of bolt 814 (See FIG. 10 and FIG. 11) and extends back through a second aperture 817 (FIG. 10) in bolt 814. Bolt 814 with square nut 820 may slide anywhere on channel strut 202 so long as a whole is present on back side 806 though which bolt 814 may extend therethrough. When bolt 814 is turned (buy turning bolt head) square nut 820 is tightened on channel strut 802 to clamp z purlin 826 to channel strut 802. Nut 822 may be tightened to lock guidewire 824 with bolt 814.

Referring to FIG. 9 and FIG. 10, bolt 914 is forms aperture 915 extending from one end of bolt (via the cap 917 of bolt 914) to the other end of bolt 914. Bolt 914 has a second aperture 817 formed by bolt 914 adjacent the first aperture 915 at the other end is drilled into bolt 914 and extends partially into bolt 914. Guide wire 924 extends through aperture 915 in bolt 914 out the other end. Guide wire 924 is wrapped around extending back into second aperture 817. Referring to FIGS. 8 and 9, guidewire 914 is then held in place using nut 822.

Referring to FIG. 11, Z perlins 1102a-n are shown coupled to a strut 1104 and to ceiling 105. A hole 1106 may be drilled through one or more of Z perlins 1102a-n for insertion of a bolt (e.g., bolt 914) and a stiffener 1110. Z Purlins 102a-n are preferably rigid in the vertical plane (see images) and will flex in the horizontal plane. In this case, during installation a stiffener may be used in the Z Purlin. If a structural member such as if an I beam is present, then the stiffener can be omitted, and the bolt can be installed directly through a single hole in a channel strut. Alternatively, bolt 914 may be installed in any structural member (wall or ceiling) that is in a suitable position for attachment.

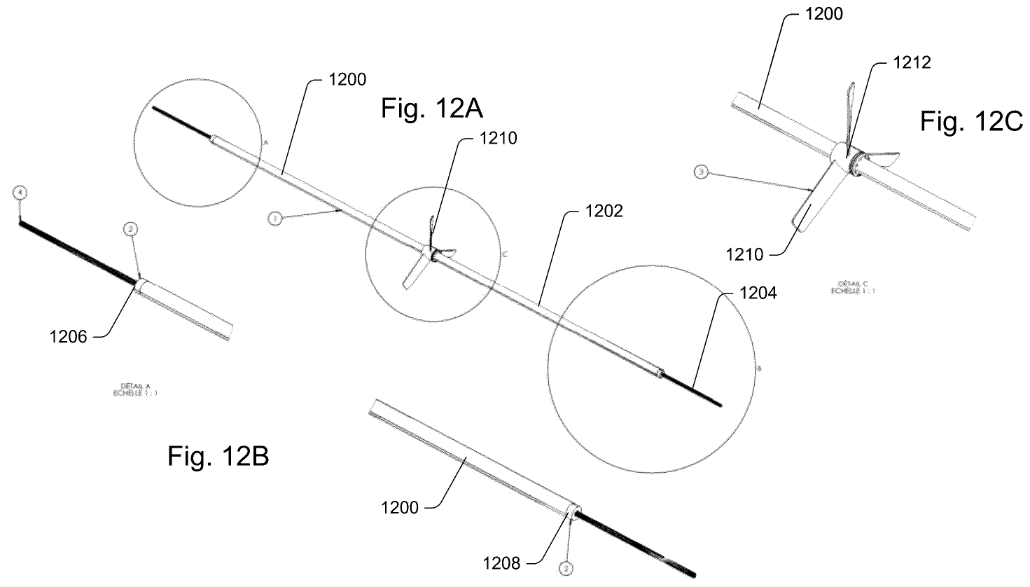

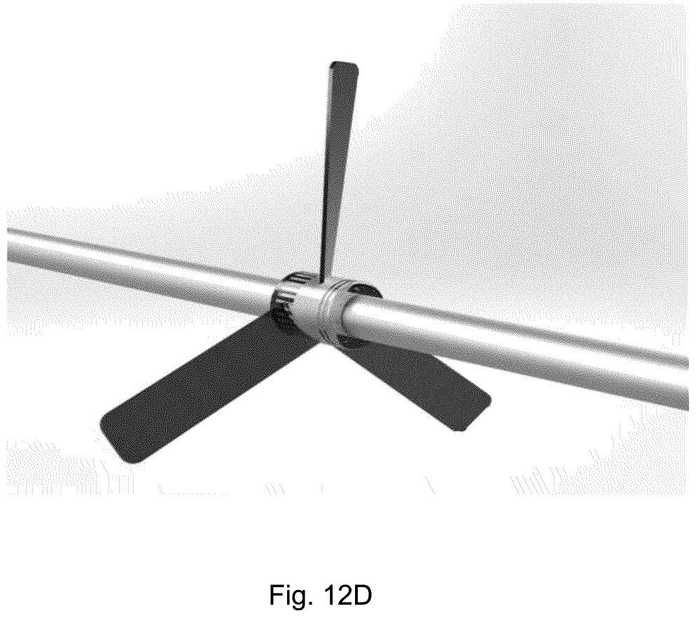

Referring to FIGS. 12A-12D there is shown a rotatable guidewire cover 1200. Cover 1200 includes Tube 1202 covering a guidewire 1204. Tube 1202 may have caps 1206 and 1208 engaging with each end of tube 1202 and may be locked to guide wire 1202. Caps 1206 and 1208 engage with guidewire 1204 and tubes 1202 to prevent tube 1202 from sliding on guide wire 1204. Tube 1202 may be painted in a candy cane pattern with 2 or more colors. Tube 1202 rotates on guidewire 1204. Fan blades 1210 that extend perpendicularly away from tube 1202 and are attached directly or with a pivot section 1212.

During operation, when air blows in the direction of fan blades 1210, such as air generated from a fan 102 (having fan blades (not shown)), rotate with tube 1204 as fan blades 1210 are locked to tube 1202. Tube 1202 then rotates around guidewire 1204, resulting in colors on tube 1202 appearing to flash. The flashing tube thus provides an increased visibility of the guide wire 1204 so the guidewire 1204 does not get bumped.

While the above detailed description has shown, described and identified several novel features of the invention as applied to a preferred embodiment, it will be understood that various omissions, substitutions and changes in the form and details of the described embodiments may be made by those skilled in the art without departing from the spirit of the invention. Accordingly, the scope of the invention should not be limited to the foregoing discussion but should be defined by the appended claims.

What is claimed is:

1. An apparatus for securing a guidewire to a receiving structure that supports a fan, the apparatus comprising:
a retainer having a bolt integrally connected to a body portion, the bolt and body portion forming a hollow interior through which the guide wire is operative to extend through, the walls of the hollow interior of the body portion forming a cylinder, the body portion having external threads operative to screw into an opening formed on a wall of the receiving structure in response to turning the bolt to secure the retainer to the receiving structure; and
a semi-spherical cap operative to attach to one end of the guidewire extending through the hollow interior, the cap having a maximum diameter smaller than a diameter of the opening formed in the receiving structure to enable insertion of the cap into the receiving structure via the aperture and having minimum diameter larger than the diameter of the cylinder to prevent the cap and guidewire from being pulled through the hollow interior.

2. The apparatus as recited in claim 1 wherein the walls of the hollow interior of the body portion taper inward from the bolt toward the cylinder.

3. The apparatus as recited in claim 2, wherein the walls of the hollow interior of the bolt taper outward proportionally.

4. The apparatus as recited in claim 1 wherein the cap includes a spherical portion and an elongated portion integrally connected to the spherical portion, the elongates portion operative to be received in the hollow interior of the body portion.

5. The apparatus as recited in claim 1 wherein the external threads on the body portion are tapered from the bolt to an opposing end of the body portion.

6. The apparatus as recited in claim 1 wherein the receiving structure comprises at least one of a hollow tube or a solid tube.

7. A fan assembly comprising:
a fan;
a receiving structure that supports the fan;
a retainer having a bolt integrally connected to a body portion, the bolt and body portion forming a hollow interior through which a guide wire is operative to extend through, the walls of the hollow interior of the body portion forming a cylinder the body portion having external threads operative to screw into an opening formed on a wall of the receiving structure in response to turning the bolt to secure the retainer to the receiving structure; and
a semi-spherical cap operative to attach to one end of the guidewire extending through the hollow interior, the cap having a maximum diameter smaller than a diameter of an aperture formed in the receiving structure to enable insertion of the cap into the receiving structure via the opening and having minimum diameter larger than the diameter of the cylinder to prevent the cap and guidewire from being pulled through the hollow interior.

8. The fan assembly as recited in claim 7 wherein the walls of the hollow interior of the bolt taper outward from the hollow interior of the body portion.

9. The fan assembly as recited in claim 8, wherein the walls of the hollow interior of the bolt taper outward proportionally.

10. The fan assembly as recited in claim 7 wherein the cap includes a spherical portion and an elongated portion integrally connected to the spherical portion, the elongate portion operative to be received in the hollow interior of the body portion.

11. The fan assembly as recited in claim 7 wherein the external threads on the body portion are tapered from the bolt to an opposing end of the body portion.

12. The fan assembly as recited in claim 7 wherein the receiving structure comprises at least one of a hollow tube or a solid tube.

13. A method for securing a guidewire to a receiving structure that supports a fan, the apparatus comprising:
integrally connecting a bolt to a body portion to form a retainer,
forming within the bolt and body portion a hollow interior;
extending a guide wire through the hollow interior,
forming a cylinder with the walls of the hollow interior of the body portion
forming external threads on the body portion;
screwing the external threads into an opening formed on a wall of the receiving structure in response to turning the bolt to secure the retainer to the receiving structure;
attaching a semi-spherical cap to one end of the guidewire extending through the hollow interior; and
enabling insertion of the cap into the receiving structure via the aperture by forming the cap with a maximum diameter smaller than a diameter of the opening formed in the receiving structure, and forming the cap with a minimum diameter larger than the diameter of the cylinder to prevent the cap and guidewire from being pulled through the hollow interior.

14. The method as recited in claim 13 further comprising tapering the walls of the hollow interior of the body portion inward from the bolt toward the cylinder.

15. The method as recited in claim 14, further comprising tapering the walls of the hollow interior of the bolt outward proportionally.

16. The method as recited in claim 15 further comprising integrally connecting a spherical portion of the cap to an elongated portion and receiving the elongated portion in the hollow interior of the body portion.

17. The method as recited in claim 14 further comprising tapering the external threads on the body portion from the bolt to an opposing end of the body portion.

18. The method as recited in claim 1 wherein the receiving structure comprises at least one of a hollow tube or a solid tube.
